(19) United States
(12) Patent Application Publication
(10) Pub. No.: US 2009/0185843 A1
(43) Pub. Date: Jul. 23, 2009

(54) Image Forming Device and Cleaning Device

(75) Inventors: Satoshi CHIBA, Suwa-shi (JP); Ken IKUMA, Suwa-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/353,746

(22) Filed: Jan. 14, 2009

(30) Foreign Application Priority Data
Jan. 21, 2008 (JP) 2008-010054
Oct. 14, 2008 (JP) 2008-264768

(51) Int. Cl. G03G 21/00

(52) U.S. Cl. 399/348

(57) ABSTRACT

An image forming device includes a development section provided with a developer carrier adapted to perform development using a liquid developer including a carrier liquid and toner particles, an image carrier adapted to carry an image developed by the development section, an cleaning roller of the image carrier having contact with the image carrier, an cleaning blade of the cleaning roller of the image carrier having contact with the cleaning roller of the image carrier at one of a position on an imaginary line of an intersection between an imaginary plane passing through a center of a rotational axis of the cleaning roller of the image carrier and perpendicular to an imaginary vertical plane and a surface of the cleaning roller of the image carrier and a position lower than the imaginary line in a vertical direction, and an image carrier recovery reservoir adapted to store the liquid developer recovered by the cleaning blade of the cleaning roller of the image carrier.

### BACKGROUND

1. Technical Field

The present invention relates to a cleaning device adapted to clean an image carrier and an intermediate transfer member, the image carrier having a latent image formed on the surface thereof with a liquid developer composed of toner particles and a carrier, the latent image being developed, and the developed image being transferred to the intermediate transfer member. The invention also relates to an image forming device using such a cleaning device.

2. Related Art

There are proposed various types of wet image forming device developing a latent image using a high-viscosity liquid developer obtained by dispersing toner particles made of a solid component in a liquid solvent, thereby visualizing the electrostatic latent image. The developer used in such wet image forming devices has solid components (the toner particles) suspended in a high-viscosity organic solvent (a carrier liquid) with an electric insulation property made of silicon oil, mineral oil, or edible oil. The toner particles are very fine particles with a particle diameter of about lam. By using such fine toner particles, a higher image quality can be achieved by the wet image forming devices in comparison with the dry image forming devices using powder toner particles with a particle diameter of about 7 μm.

In the image forming device using the liquid developer described above, it is required to provide a cleaning device for removing the liquid developer attached to a roller and so on constituting the device. As such a cleaning device, for example, there is described in JP-A-2005-148239 (Document 1) a liquid development device having a developer carrier adapted to hold on a surface thereof a high-viscosity and high-concentration liquid developer dispersing toner in a carrier liquid and to carry the liquid developer, and a developer removing section adapted to remove the liquid developer on the developer carrier, and characterized in being constituted by an electric field providing member and a developer removing member, the developer removing section removing the developer by applying an electric field with the electric field providing member, and the developer removing member having contact with a surface of the developer carrier with appropriate pressure on the downstream side of the electric field providing member in a moving direction of the surface of the developer carrier and removing the developer with shearing force.

However, the removal of the developer in the device described in the Document 1 is directed to the development roller, and for removing the liquid developer not yet processed by a squeezing process for removing the carrier liquid, and in this case, even if the member for providing the electric field is used as the developer removing section, there is no chance to significantly damage the easiness in conveying the liquid developer thus removed.

However, in the case of removing the toner image on the image carrier or the intermediate transfer member having passed through the squeezing process, if the liquid developer is removed by separating the carrier liquid and the toner particles using the removing section for providing the electric field, since the removed liquid developer is rich in the solid components and contains a lot of solid components, the fluidity thereof is damaged to cause a problem that the easiness in conveying and the easiness in handling are poor, and the easiness in treating the recovery mechanism is poor.

### SUMMARY

In view of the problem described above, an image forming device according to an aspect of the invention includes a development section provided with a developer carrier adapted to perform development using a liquid developer including a carrier liquid and toner particles, an image carrier adapted to carry an image developed by the development section, an cleaning roller of the image carrier having contact with the image carrier, an cleaning blade of the cleaning roller of the image carrier having contact with the cleaning roller of the image carrier at one of a position on an imaginary line of an intersection between an imaginary plane passing through a center of a rotational axis of the cleaning roller of the image carrier and perpendicular to an imaginary vertical plane and a surface of the cleaning roller of the image carrier and a position lower than the imaginary line in a vertical direction, and an image carrier recovery reservoir adapted to store the liquid developer recovered by the cleaning blade of the cleaning roller of the image carrier.

Further, according to another aspect of the invention, in the image forming device described above, there is further provided an image carrier cleaning blade having contact with the image carrier, and the image carrier recovery reservoir stores the liquid developer recovered by the image carrier cleaning blade.

Further, according to another aspect of the invention, in the image forming device described above, there is further provided a cleaning blade holding member adapted to hold the image carrier cleaning blade, and the cleaning blade holding member is disposed vertically below a contact section between the image carrier and the cleaning roller of the image carrier.

Further, according to another aspect of the invention, in the image forming device described above, a length of the image carrier cleaning blade in a first direction is longer than a length of the cleaning blade of the cleaning roller of the image carrier in the first direction.

Further, according to another aspect of the invention, in the image forming device described above, a length of the cleaning roller of the image carrier in the first direction is longer than a length of the cleaning blade of the cleaning roller of the image carrier in the first direction, and shorter than a length of the image carrier cleaning blade in the first direction.

Further, according to another aspect of the invention, in the image forming device described above, the developer carrier is a development roller, and a length of the development roller in the first direction is shorter than a length of the cleaning roller of the image carrier in the first direction.

Further, according to another aspect of the invention, in the image forming device described above, there is further provided an applicator roller provided with grooves and adapted to apply the liquid developer to the development roller, and a length of a grooved area of the applicator roller provided with the grooves in the first direction is shorter than a length of the cleaning blade of the cleaning roller of the image carrier in the first direction.

Further, according to another aspect of the invention, in the image forming device described above, there is further provided a bias applying section adapted to apply a bias to the liquid developer of the development roller, and a length of the bias applying section in the first direction is shorter than a length of the cleaning blade of the cleaning roller of the image carrier in the first direction.

Further, according to another aspect of the invention, in the image forming device described above, the cleaning roller of the image carrier is provided with a cleaning bias.

Further, according to another aspect of the invention, in the image forming device described above, the carrier liquid is a nonvolatile carrier.

Further, according to another aspect of the invention, in the image forming device described above, the image carrier is an amorphous silicon photoconductor.

Further, a cleaning device according to still another aspect of the invention includes a cleaning roller, a cleaning blade of the cleaning roller having contact with the cleaning roller at one of a position on an imaginary line of an intersection between an imaginary plane passing through a center of a rotational axis of the cleaning roller and perpendicular to an imaginary vertical plane and a surface of the cleaning roller and a position lower than the imaginary line in a vertical direction, and a reservoir adapted to store a recovered substance recovered by the cleaning blade of the cleaning roller.

Further, according to another aspect of the invention, in the cleaning device described above, there is further provided a cleaning blade having contact with a cleaned member cleaned by the cleaning roller, and the reservoir stores a recovered substance recovered by the cleaning blade.

Further, according to another aspect of the invention, in the cleaning device described above, a length of the cleaning blade in a first direction is longer than a length of the cleaning blade of the cleaning roller in the first direction.

As described above, according to the aspects of the invention, it becomes possible to drop the liquid developer scraped off by the cleaning blade of the cleaning roller of the image carrier without running along the cleaning roller of the image carrier. Further, since the liquid developer scraped off by the cleaning blade of the cleaning roller of the image carrier is a liquid developer rich in the solid components, and has a lot of solid components, the easiness in conveying is poor. However, since the liquid developer scraped off by the image carrier cleaning blade, which is a liquid developer rich in the carrier component, is joined with the liquid developer scraped off by the cleaning blade of the cleaning roller of the image carrier to improve the easiness in conveying, and is guided to the image carrier recovery reservoir, there can be obtained an advantage of improving the easiness in treatment in the image carrier recovery reservoir.

Further, according to the aspects of the invention, it is possible to efficiently join the liquid developer rich in the carrier component scraped off throughout the length of the image carrier cleaning blade in the axial direction and the liquid developer rich in the solid components scraped off by the cleaning blade of the cleaning roller of the image carrier, thereby improving the easiness in conveying the liquid developer.

Further, according to the aspects of the invention, since the carrier is a nonvolatile carrier, it becomes possible to improve the easiness in conveying by joining the liquid developer scraped off by the cleaning blade of the cleaning roller of the image carrier and rich in the solid components and the liquid developer scraped off by the image carrier cleaning blade and rich in the carrier component together with each other.

Further, in the case in which the surface layer of the image carrier is made of amorphous silicon, the phenomenon that the toner particles remaining after the transfer process cause frictional electrification with a member having contact therewith such as the blade to damage the member is apt to occur. However, according to the aspects of the invention, since the cleaning is performed with the configuration mainly composed of the cleaning roller of the image carrier on the downstream side of the transfer section, there is no chance of damaging the surface layer of the image carrier.

Further, according to the aspects of the invention, the intermediate transfer member has elasticity, and therefore, it is difficult to press the blade for cleaning against the intermediate transfer member with high pressure. However, in the aspects of the present invention, since the intermediate transfer member is cleaned with the intermediate transfer member cleaning roller to which the bias voltage is applied, there is no possibility of damaging the intermediate transfer member with elasticity.

It should be confirmed that in relation to the above aspects of the invention, referential aspects as described below are also advantageous configurations. Specifically, a cleaning device according to a referential aspect of the invention includes an image carrier adapted to carry a developed image with a liquid developer including a carrier and toner particles, an cleaning roller of the image carrier having contact with the image carrier, an cleaning blade of the cleaning roller of the image carrier having contact with the cleaning roller of the image carrier, an image carrier cleaning blade having contact with the image carrier, and an image carrier recovery reservoir adapted to receive the liquid developer removed by the cleaning blade of the cleaning roller of the image carrier and the liquid developer removed by the image carrier cleaning blade, and a position at which the cleaning blade of the cleaning roller of the image carrier has contact with the cleaning roller of the image carrier is in a lower half area of the cleaning roller of the image carrier viewed from a direction of gravitational force.

Further, according to another referential aspect of the invention, in the cleaning device described above, the cleaning roller of the image carrier is provided with a bias.

Further, according to another referential aspect of the invention, in the cleaning device described above, the liquid developer removed by the image carrier cleaning blade having contact with the image carrier and the liquid developer removed by the cleaning blade of the cleaning roller of the image carrier are joined with each other, and then guided to the image carrier recovery reservoir.

Further, according to another referential aspect of the invention, in the cleaning device described above, a length (c) of the image carrier cleaning blade in an axial direction is set longer than a length (b) of the cleaning blade of the cleaning roller of the image carrier in an axial direction.

Further, according to another referential aspect of the invention, in the cleaning device described above, the carrier is a nonvolatile carrier.

Further, an image forming device according to another referential aspect of the invention includes an image carrier adapted to carry a developed image with a liquid developer including a carrier and toner particles, an cleaning roller of the image carrier having contact with the image carrier, an cleaning blade of the cleaning roller of the image carrier having contact with the cleaning roller of the image carrier, an image carrier cleaning blade having contact with the image carrier, an image carrier recovery reservoir adapted to receive the liquid developer removed by the cleaning blade of the cleaning roller of the image carrier and the liquid developer removed by the image carrier cleaning blade, and a recovery screw provided to the image carrier recovery reservoir and adapted to convey the liquid developer, and a position at which the cleaning blade of the cleaning roller of the image carrier has contact with the cleaning roller of the image carrier is in a lower half area of the cleaning roller of the image carrier viewed from a direction of gravitational force.

Further, according to another referential aspect of the invention, in the image forming device described above, the image carrier is an amorphous silicon photoconductor.

Further, an image forming device according to still another referential aspect of the invention includes an intermediate transfer member having elasticity, and adapted to carry a transfer image with a liquid developer including a carrier and toner particles, an intermediate transfer member cleaning roller having contact with the intermediate transfer member and adapted to clean the intermediate transfer member while being provided with a bias, an intermediate transfer member cleaning blade of the cleaning roller having contact with the intermediate transfer member cleaning roller and adapted to clean the intermediate transfer member cleaning roller, an intermediate transfer member cleaning blade having contact with the intermediate transfer member and adapted to clean the intermediate transfer member, and an intermediate transfer member recovery reservoir adapted to receive the liquid developer removed by the intermediate transfer member cleaning blade of the cleaning roller and the liquid developer removed by the intermediate transfer member cleaning blade, and a position at which the intermediate transfer member cleaning blade of the cleaning roller has contact with the intermediate transfer member cleaning roller is in a lower half area of the intermediate transfer member cleaning roller viewed from a direction of gravitational force.

As described above, according to the referential aspects of the invention, it becomes possible to drop the liquid developer scraped off by the cleaning blade of the cleaning roller of the image carrier without running along the cleaning roller of the image carrier. Further, since the liquid developer scraped off by the cleaning blade of the cleaning roller of the image carrier is a liquid developer rich in the solid components, and has a lot of solid components, the easiness in conveying is poor. However, since the liquid developer scraped off by the image carrier cleaning blade, which is a liquid developer rich in the carrier component, is joined with the liquid developer scraped off by the cleaning blade of the cleaning roller of the image carrier to improve the easiness in conveying, and is guided to the image carrier recovery reservoir, there can be obtained an advantage of improving the easiness in treatment in the image carrier recovery reservoir.

Further, according to the referential aspects of the invention, it is possible to efficiently join the liquid developer rich in the carrier component scraped off throughout the length of the image carrier cleaning blade in the axial direction and the liquid developer rich in the solid components scraped off by the cleaning blade of the cleaning roller of the image carrier, thereby improving the easiness in conveying the liquid developer.

Further, according to the referential aspects of the invention, since the carrier is a nonvolatile carrier, it becomes possible to improve the easiness in conveying by joining the liquid developer scraped off by the cleaning blade of the cleaning roller of the image carrier and rich in the solid components and the liquid developer scraped off by the image carrier cleaning blade and rich in the carrier component together with each other.

Further, in the case in which the surface layer of the image carrier is made of amorphous silicon, the phenomenon that the toner particles remaining after the transfer process causes frictional electrification with a member having contact with each other such as the blade to damage the member is apt to occur. However, according to the referential aspects of the invention, since the cleaning is performed with the configuration mainly composed of the cleaning roller of the image carrier on the downstream side of the transfer section, there is no chance of damaging the surface layer of the image carrier.

Further, according to the referential aspects of the invention, the intermediate transfer member has elasticity, and therefore, it is difficult to press the blade for cleaning against the intermediate transfer member with high pressure. However, in the aspects of the present invention, since the intermediate transfer member is cleaned with the intermediate transfer member cleaning roller to which the bias voltage is applied, there is no possibility of damaging the intermediate transfer member with elasticity.

### BRIEF DESCRIPTION OF THE DRAWINGS

The invention will now be described with reference to the accompanying drawings, wherein like numbers reference like elements.

FIG. 1 is a diagram showing principal constituents forming an image forming device according to an embodiment of the invention.

FIG. 2 is a cross-sectional view showing principal constituents of an image forming section and a cleaning device.

FIGS. 3A and 3B are diagrams showing examples of an arrangement of the cleaning device according to the embodiment of the invention.

FIGS. 4A and 4B are diagrams respectively showing a stopping state and an operating state of the development device according to the embodiment of the invention.

FIG. 5 is a diagram showing flow of the liquid developer in the development device.

FIG. 6 is a perspective view of an anilox roller used in the embodiment of the invention.

FIG. 7 is a diagram showing a configuration of a cleaning device in a secondary transfer unit.

FIG. 8 is a diagram showing a configuration of a cleaning device of an intermediate transfer member.

FIG. 9 is a diagram showing a dimensional relationship in the axial direction in the peripheral area of the cleaning device according to the embodiment of the invention.

FIG. 10 is a diagram showing a dimensional relationship in the axial direction in the peripheral area of the cleaning device according to the embodiment of the invention.

FIG. 11 is a diagram showing principal constituents forming an image forming device according to another embodiment of the invention.

FIGS. 12A and 12B are diagrams showing an example of an arrangement of the cleaning device according to the another embodiment of the invention.

FIG. 13 is a diagram showing an example of a configuration of the cleaning device of the intermediate transfer member according to the another embodiment of the invention.

FIG. 14 is a diagram showing a dimensional relationship in the axial direction of the peripheral area of the cleaning device according to the another embodiment of the invention.

### DESCRIPTION OF EXEMPLARY EMBODIMENTS

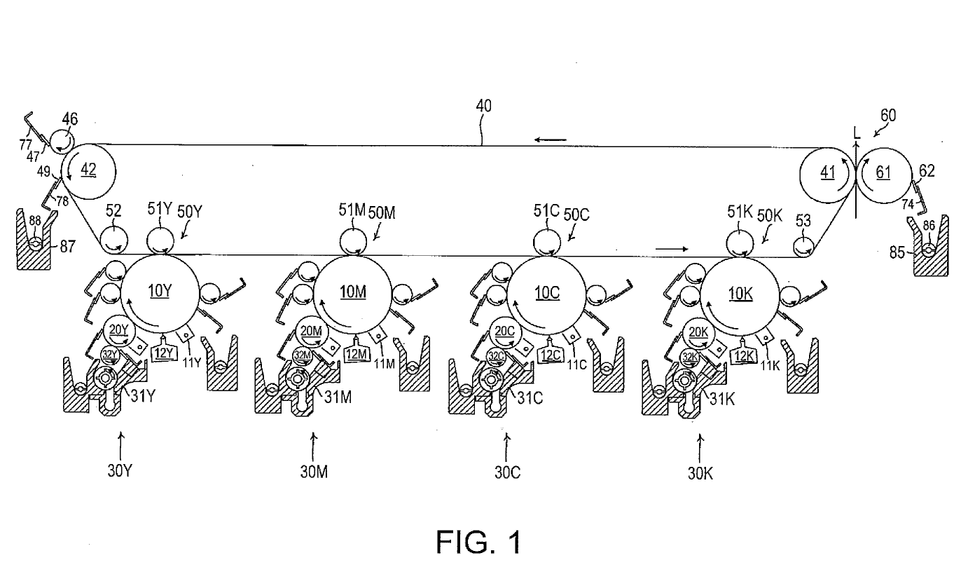

Some embodiments of the invention will hereinafter be explained with reference to the accompanying drawings. FIG. 1 is a diagram showing principal constituents forming the image forming device according to an embodiment of the invention. With respect to the image forming sections for respective colors disposed in the center area of the image forming device, development devices 30Y, 30M, 30C, and 30K are disposed in a lower area of the image forming device, and an intermediate transfer member 40 and a secondary transfer section (a secondary transfer unit) 60 are disposed in an upper area of the image forming device.

The image forming section is provided with image carriers 10Y, 10M, 10C, and 10K, corona chargers 11Y, 11M, 11C, and 11K, exposure units 12Y, 12M, 12C, and 12K (not shown), and so on. The exposure units 12Y, 12M, 12C, and 12K are each provided with a line head composed of LEDs or organic EL elements and an optical system, and the image carriers 10Y, 10M, 10C, and 10K are evenly charged by the corona chargers 11Y, 11M, 11C, and 11K, and then laser beams modulated in accordance with image signals input therein are applied on the image carriers 10Y, 10M, 10C, and 10K thus charged using the exposure units 12Y, 12M, 12C, and 12K, thereby forming electrostatic latent images thereon, respectively.

The development devices 30Y, 30M, 30C, and 30K are mainly provided with development rollers 20Y, 20M, 20C, and 20K, developer containers (reservoirs) 31Y, 31M, 31C, and 31K for reserving the liquid developers of various colors composed of yellow (Y), magenta (M), cyan (C), and black (K), anilox rollers 32Y, 32M, 32C, and 32K as applicator rollers for applying the liquid developers of the various colors from the developer containers 31Y, 31M, 31C, and 31K to the development rollers 20Y, 20M, 20C, and 20K, respectively, and develop the electrostatic latent images formed on the image carriers 10Y, 10M, 10C, and 10K with the liquid developers of the respective colors.

The intermediate transfer member 40 is an endless belt, stretched across a belt drive roller 41 and tension rollers 42, 52, and 53, and rotationally driven by the belt drive roller 41 while having contact with the image carriers 10Y, 10M, 10C, and 10K at primary transfer sections 50Y, 50M, 50C, and 50K, respectively. The primary transfer sections 50Y, 50M, 50C, and 50K have primary transfer rollers 51Y, 51M, 51C, and 51K disposed across the intermediate transfer member 40 from the image carriers 10Y, 10M, 10C, and 10K, respectively, and forms a full-color toner image by sequentially stacking on the intermediate transfer member 40 the toner images of respective colors on the image carriers 10Y, 10M, 10C, and 10K thus developed at transfer positions at which the intermediate transfer member 40 and the image carriers 10Y, 10M, 10C, and 10K have contact with each other, respectively.

The secondary transfer unit 60 has a secondary transfer roller 61 disposed so as to face the belt drive roller 41 with the intermediate transfer section 40 intervening between them, and has a cleaning device composed mainly of a secondary transfer roller cleaning blade 62 disposed therein. Further, at the transfer position at which the secondary roller 61 is disposed, the monochromatic toner image or the full-color toner image formed on the intermediate transfer member 40 is transferred to the recording medium such as a paper sheet, a film, or cloth conveyed along the sheet member transport path L.

Further, on the downstream side of the secondary transfer section, there is disposed a fixing unit, not shown, for fusion bonding the monochromatic toner image or the full-color toner image transferred on the recording medium such as a paper sheet to the recording medium such as a paper sheet, thus fixing the image to the recording medium.

Further, the tension roller 42 stretches the intermediate transfer roller 40 in cooperation with the belt drive roller 41, and at a part of the intermediate transfer member 40 at which the intermediate transfer member 40 is stretched by the tension roller 42, the cleaning device mainly composed of the intermediate transfer member cleaning roller 46 is disposed so as to have contact with the intermediate transfer member 40.

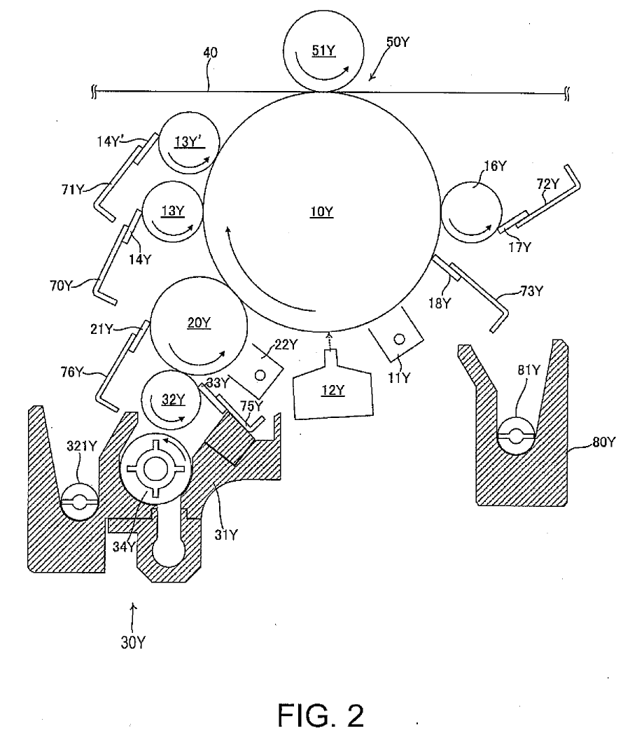

Then, the image forming section and the cleaning device of the image forming device according to the embodiment of the invention will hereinafter be explained. FIG. 2 is a cross-sectional view showing principal constituents of the image forming section and the cleaning device. Since the configurations of the image forming sections and the development devices for respective colors are substantially the same, the explanations will hereinafter be presented based on the image forming section and the development device for yellow (Y).

The image forming section has an cleaning roller of the image carrier 16Y, an image carrier cleaning blade 18Y, the corona charger 11Y, the exposure unit 12Y, the development roller 20Y of the image development device 30Y, and image carrier squeezing rollers 13Y, 13Y′ disposed on the outer peripheral area of the image carrier 10Y along the rotational direction thereof.

The cleaning roller of the image carrier 16Y is a roller having a surface layer made of urethane rubber, and rotates counterclockwise while having contact with the image carrier 10Y, thereby removing the residual liquid developer after transfer process and the liquid developer, which has not yet been transferred, remaining on the image carrier 10Y. The cleaning roller of the image carrier 16Y is provided with a bias voltage so as to attract the toner particles in the liquid developer. Therefore, what is recovered by the cleaning roller of the image carrier 16Y should be the liquid developer containing a lot of toner particles. Such a liquid developer recovered by the cleaning roller of the image carrier 16Y, and rich in the sold components is scraped off by the cleaning blade of the cleaning roller of the image carrier 17Y having contact with the cleaning roller of the image carrier 16Y, and falls vertically downward.

In contrast, the image carrier cleaning blade 18Y having contact with the image carrier 10Y on the downstream side of the cleaning roller of the image carrier 16Y makes the liquid developer on the image carrier 10Y, which is rich in the carrier component, fall downward via a cleaning blade holding member 73Y.

It should be noted that the words “rich in the solid components” denote the state of the liquid developer containing more solid components in comparison with the liquid developer with adjusted concentration to be supplied to the development device 30Y. In contrast, the words “rich in the carrier component” denote the state of the liquid developer containing more carrier component in comparison with the liquid developer to be supplied to the development device 30Y. Further, it is possible to define the liquid developer (toner) as the solid components (the toner particles) dispersed in the carrier.

On the cleaning blade holding member 73Y, the liquid developer rich in the solid components dropping from the cleaning blade of the cleaning roller of the image carrier 17Y and the liquid developer rich in the carrier component scraped off by the image carrier cleaning blade 18Y are mixed with each other, thus the easiness in conveying thereof is improved. Further, such improvement in the easiness in conveying can make a contribution to down sizing of the device.

An image carrier recovery reservoir 80Y has a recessed section for receiving both of the liquid developer rich in the solid components scraped off by the cleaning blade of the cleaning roller of the image carrier 17Y and the liquid developer rich in the carrier component scraped off by the image carrier cleaning blade 18Y.

The recessed section of the image carrier recovery reservoir 80Y is provided with a recovery screw 81Y, and when the recovery screw 81Y rotates, spiral blades thereof convey the liquid developer received by the recessed section in the axial direction of the rotating shaft of the recovery screw 81Y. The liquid developer conveyed by the recovery screw 81Y is discharged to a recovery mechanism not shown.

The reference marks 70Y, 71Y, 72Y, and 73Y denote the cleaning blade holding members for holding the respective cleaning blades.

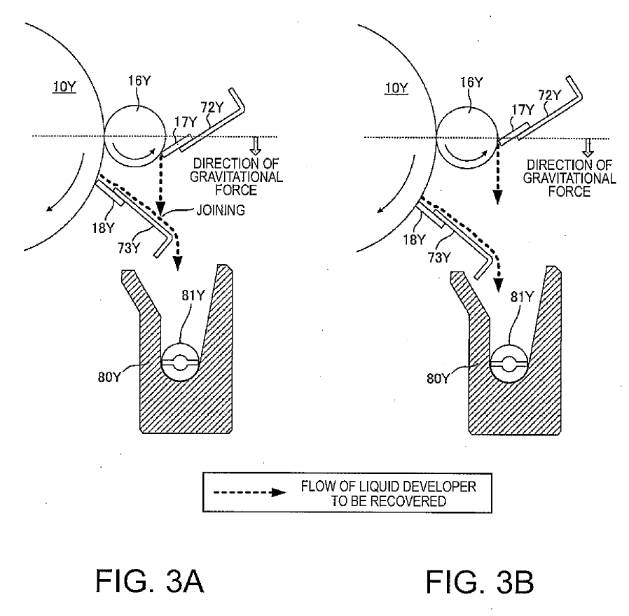

FIGS. 3A and 3B are diagrams showing examples of an arrangement of the cleaning device according to the embodiment of the invention. Although FIG. 3A and FIG. 3B both show the cleaning device according to the embodiment of the invention, the positions at which the cleaning blade of the cleaning roller of the image carrier 17Y and the image carrier cleaning blade 18Y have contact therewith are different from each other.

In the cleaning device of the embodiment of the invention, the position at which the cleaning blade of the cleaning roller of the image carrier 17Y have contact with the cleaning roller of the image carrier 16Y is preferably in the lower half of the cleaning roller of the image carrier 16Y viewed from the direction of gravitational force thereof as shown in FIGS. 3A and 3B. The reason therefor is that the liquid developer scraped off by the cleaning blade of the cleaning roller of the image carrier 17Y can be dropped without running along the cleaning roller of the image carrier 16Y.

The liquid developer scraped off by the cleaning blade of the cleaning roller of the image carrier 17Y is dropped on the cleaning blade holding member 73Y in the example shown in FIG. 3A, while it is dropped directly to the recessed section of the image carrier recovery reservoir 80Y in the example shown in FIG. 3B.

Since the liquid developer scraped off by the cleaning blade of the cleaning roller of the image carrier 17Y is a liquid developer rich in the solid components, and has a lot of solid components, the easiness in conveying the liquid developer along the axial direction of the rotating shaft of the recovery screw 81Y is poor. Therefore, by adopting the positional relationship shown in FIG. 3A, there is obtained an advantage that the liquid developer rich in the carrier component, which is scraped off by the image carrier cleaning blade 18Y joins together with the liquid developer scraped off by the cleaning blade of the cleaning roller of the image carrier 17Y on the cleaning blade holding member 73Y, thus the easiness in conveying the liquid developer to be recovered is improved. Therefore, the easiness in treatment in the image carrier recovery reservoir 80Y is improved. Here, although the example of dropping the liquid developer scraped off by the cleaning blade of the cleaning roller of the image carrier 17Y on the cleaning blade holding member 73Y is described, it is possible to arrange that the liquid developer drops directly on the image carrier cleaning blade 18Y.

In such a configuration of the present embodiment, the image carrier recovery reservoir 80Y recovers both of the liquid developer removed by the cleaning blade of the cleaning roller of the image carrier 17Y and the liquid developer removed by the image carrier cleaning blade 18Y. By conveying the recovered substance recovered by the cleaning roller of the image carrier 16Y and apt to have a relatively high concentration of the solid components (the toner components) together with the recovered substance recovered by the image carrier cleaning blade 18Y and rich in the carrier component, it becomes easier to convey the recovered substance recovered by the image carrier creaming roller 16Y, which is apt to have a high concentration of the solid components, and downsizing of the device can be achieved.

Further, in the present embodiment, since the carrier used in the liquid developer is a nonvolatile carrier, it becomes possible to improve the easiness in conveying by joining the liquid developer scraped off by the cleaning blade of the cleaning roller of the image carrier 17Y and rich in the solid components and the liquid developer scraped off by the image carrier cleaning blade 18Y and rich in the carrier component together with each other.

Further, in the present embodiment, the surface layer of the image carrier 10Y is made of amorphous silicon, and such an amorphous silicon surface layer apt to cause the phenomenon that the toner particles remaining after the transfer process cause frictional electrification with a member having contact therewith such as the blade to damage the member. In the present embodiment, since the cleaning is executed by the configuration mainly composed of the cleaning roller of the image carrier 16Y described above on the downstream side of the transfer, there is no chance that the surface layer of the image carrier 10Y is damaged.

In the outer peripheral area of the development roller 20Y in the development device 30Y, there are disposed the development roller cleaning blade 21Y, the anilox roller 32Y, and a compaction corona generator 22Y. The anilox roller 32Y has contact with a limiting blade 33Y for adjusting an amount of liquid developer to be supplied to the development roller 20Y. The reference mark 75Y denotes a blade holding member for holding the limiting blade 33Y. In the developer container 31Y, there are housed an auger 34Y and a recovery screw 321Y.

Further, the primary transfer roller 51Y of the primary transfer section is disposed at a position opposed to the image carrier 10Y along the intermediate transfer member 40.

The image carrier 10Y is a photoconductor drum formed of a cylindrical member having a width greater than the width of the development roller 20Y, and provided with a photoconductor layer formed on the outer circumferential surface thereof, and rotates, for example, in a clockwise direction as shown in FIG. 2. The photoconductor layer as the surface layer of the image carrier 10Y is formed of an amorphous silicon image carrier. The corona charger 11Y is disposed upstream of a nip section between the image carrier 10Y and the development roller 20Y in the rotational direction of the image carrier 10Y, and provided with a bias voltage applied from a power supply device, not shown, thus charging the image carrier 10Y. The exposure unit 12Y applies LED light or the like to the surface of the image carrier 10Y thus charged by the corona charger 11Y on a downstream side of the corona charger 11Y in the rotational direction of the image carrier 11Y, thereby forming a latent image on the image carrier 10Y.

It should be noted that it is defined that in the start through the end of the image formation process, a constituent such as a roller disposed in a more anterior stage is disposed on the upstream side of a constituent such as a roller disposed in a posterior stage.

The development device 30Y has the compaction corona generator 22Y for exerting a charging influence to the toner particles, and the developer container 31Y for storing the liquid developer in the condition of dispersing the toner particles in the carrier at a weight ratio of about 20%. The developer container 31Y is also provided with the recovery screw 321Y for recovering the liquid developer not supplied to the anilox roller 32Y.

Further, the development device 30Y is provided with the development roller 20Y for carrying the liquid developer described above, the anilox roller 32Y as the applicator roller for applying the liquid developer to the development roller 20Y, the limiting blade 33Y for regulating the amount of liquid developer to be applied to the development roller 20Y, the auger 34Y for supplying the liquid developer to the anilox roller 32Y while agitating and conveying the liquid developer, the compaction corona generator 22Y for making the liquid developer carried by the development roller 20Y be in the charged state, and the development roller cleaning blade 21Y for cleaning the development roller 50Y. The reference mark 76Y denotes a cleaning blade holding member for holding the development roller cleaning blade 21Y.

The liquid developer contained in the developer container 31Y is not a volatile liquid developer with low concentration (about 1 through 2 wt %), low viscosity, and room-temperature volatility, adopting Isopar (a trademark of Exxon Mobil Corporation) as the carrier, which has been commonly used in the past, but a nonvolatile liquid developer with high concentration, high viscosity, and room-temperature non-volatility. In other words, the liquid developer in the embodiment of the invention is a high-viscosity (about 30 through 10000 mPa·s) liquid developer having solid matters with an average particle diameter of 1 μm and obtained by dispersing a colorant such as a pigment in thermoplastic resin, added to a liquid solvent such as an organic solvent, silicone oil, mineral oil, or edible oil together with a dispersant to have a solid content concentration of the toner particles of about 20%.

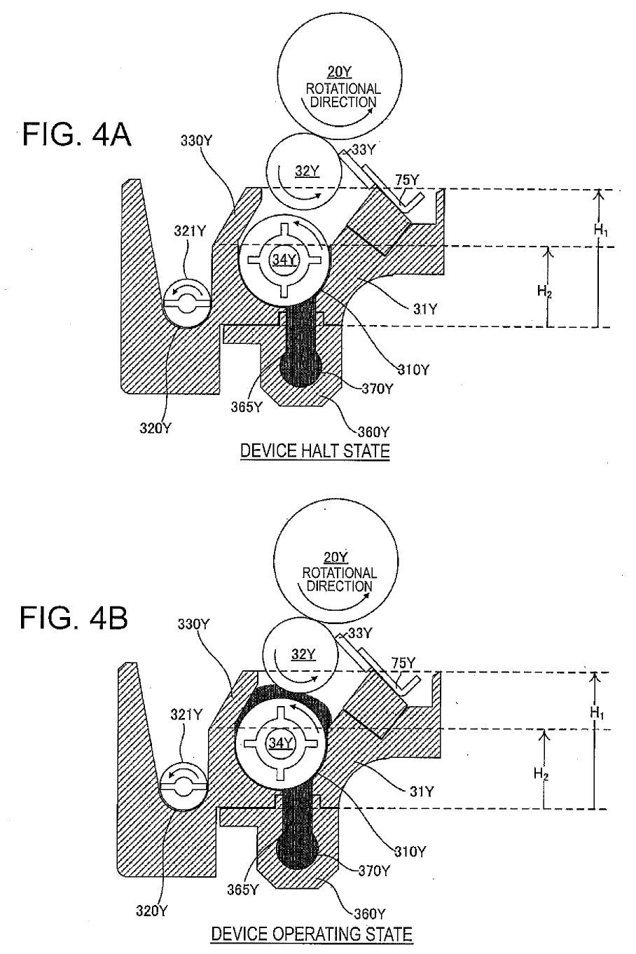

Although the auger 34Y is disposed in the developer container 31Y so as to be separated from the anilox roller 32Y, it is arranged that when the auger 34Y rotates counterclockwise in FIG. 2, the liquid developer is supplied to the anilox roller 32Y. FIGS. 4A and 4B are diagrams respectively showing a stopping state (FIG. 4A) and an operating state (FIG. 4B) of the image forming device according to the embodiment of the invention. In FIGS. 4A and 4B, the reference mark 31Y denotes the developer container, the reference mark 32Y denotes the anilox roller, the reference mark 33Y denotes the limiting blade, the reference mark 75Y denotes the limiting blade holding member, the reference mark 34Y denotes the auger, the reference mark 310Y denotes a supply reservoir, the reference mark 320Y denotes a recovery reservoir, the reference mark 321Y denotes the recovery screw, the reference mark 330Y denotes a partitioning section, the reference mark 360Y denotes a liquid developer supply member, the reference mark 365Y denotes a liquid developer supply port, the reference mark 370Y denotes a liquid developer supply tube, and the reference mark 371Y denotes a liquid developer recovery tube.

The partitioning section 330Y separates the space in the developer container 31Y into two. One of the spaces separated by the partitioning section 330Y is used as the supply reservoir 310Y for supplying the liquid developer, and the other is used as the recovery reservoir 320Y for recovering the liquid developer. The partitioning section 330Y separates the supply reservoir 310Y and the recovery reservoir 320Y from each other so as to be arranged in parallel to each other in the axial direction.

In the supply reservoir 310Y, the auger 34Y is rotatably disposed, and when the auger 34Y rotates during the operation of the device, the liquid developer stored in the supply reservoir 310Y is supplied to the anilox roller 32Y. The supply reservoir 310Y and the liquid developer supply tube 370Y are coupled to each other, and the liquid developer supply tube 370Y supplies the supply reservoir 310Y with the liquid developer.

Further, in the recovery reservoir 320Y, the recovery screw 321Y is rotatably disposed, and the recovery screw 321Y rotates during the operation of the device, thereby recovering the liquid developer, which has not been used for development, the carrier dropped from the cleaning blades such as image carrier squeezing roller cleaning blades 14Y, 14Y′, and so on.

The recovery reservoir 320Y and the liquid developer recovery tube 371Y are coupled to each other, and it is arranged that the liquid developer is conveyed to one end of the recovery reservoir 320Y to which the liquid developer recovery tube 371Y is coupled, in response to rotation of the recovery screw 321Y. The liquid developer thus recovered by the recovery reservoir 320Y is guided by the liquid developer recovery tube 371Y to a liquid developer recycling mechanism, not shown.

The partitioning section 330Y has an area with a first height (H₁) and an area with a second height (H₂) formed in different positions in the axial direction. In the present embodiment, the area with the first height (H₁) is disposed at the center part of the partitioning section 330Y, and the area with the second height (H₂) is disposed at both ends of the partitioning section 330Y, wherein the first height (H₁) is arranged to be higher than the second height (H₂).

The area with the first height (H₁) of the partitioning section 330Y functions to raise the liquid level of the liquid developer by blocking the liquid developer trying to flow towards the recovery reservoir 320Y in response to the rotation of the auger 34Y during the operation of the device. In other words, the area with the first height (H₁) is provided for making it possible to convey the liquid developer from the auger 34Y to the anilox roller 32Y only while the auger 34Y is performing the rotating operation.

The area with the second height (H₂) of the partitioning section 330Y determines the liquid level of the liquid developer in the supply reservoir 310Y in the halt state of the device. Further, in the operating state of the device, the area with the second height (H₂) forms a path for flowing the liquid developer, which is constantly supplied to the supply reservoir 310Y from the liquid developer supply tube 370Y, to the recovery reservoir 320Y.

The area with the second height (H₂) of the partitioning section 330Y has a role of determining the liquid level of the liquid developer of the supply reservoir 310Y in the halt state of the device, and thus, prevents the anilox roller 32Y from being dipped into the liquid developer in the halt state of the device.

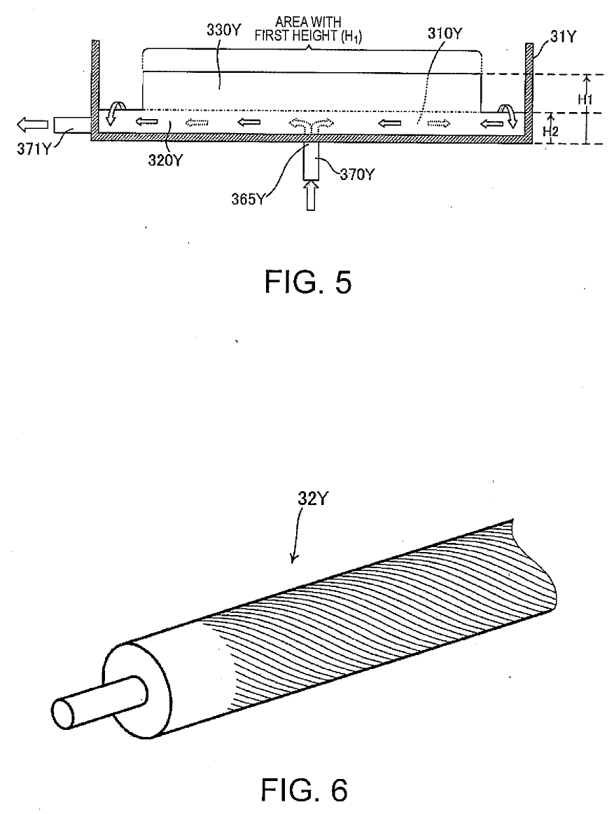

FIG. 5 shows the flow of the liquid developer when viewed from the direction traversing the axial direction of the rollers. During the operation of the device, the liquid developer supplied from the liquid developer supply port 365Y to the supply reservoir 310Y is raised in the liquid level in the area with the first height (H₁) due to the rotating operation of the auger 34Y, not shown, and at the same time, moves from the supply reservoir 310Y to the recovery reservoir 320Y beyond the partitioning section 330Y in the area with the second height (H₂). Further, the liquid developer supplied in substantially the center area of the supply reservoir 310Y is conveyed to the right and left of the drawing by the auger 34Y. The liquid developer supplied from the liquid developer supply port 365Y to the supply reservoir 310Y has been adjusted to have a constant concentration by a mechanism, not shown.

Further, in the recovery reservoir 320Y, the liquid developer is conveyed by the recovery screw 321Y, not shown, from the left to the right in the drawing, and is guided to the developer recycling mechanism, not shown, from the liquid developer recovery tube 371Y.

The anilox roller 32Y functions as the applicator roller for supplying and applying the liquid developer to the development roller 20Y. FIG. 6 is a perspective view of the anilox roller used in the embodiment of the invention. The anilox roller 32Y is a cylindrical member, and is a roller having an uneven surface with grooves finely and uniformly carved on the circumferential surface in a spiral manner so as to easily carry the developer on the circumferential surface thereof. The anilox roller 32Y supplies the liquid developer from the developer container 31Y to the development roller 20Y. During the operation of the device, as shown in FIG. 2, the auger 34Y rotates clockwise to supply the anilox roller 32Y with the liquid developer, and the anilox roller 32Y rotates counterclockwise to apply the liquid developer to the development roller 20Y.

The limiting blade 33Y is an elastic blade formed by coating the surface thereof with an elastic member, and is composed of a rubber section formed, for example, of an urethane rubber member and having contact with the surface of the anilox roller 32Y, and a plate made of metal or the like for supporting the rubber section. Thus, the limiting blade 33Y limits and controls the film thickness and the amount of the liquid developer carried and conveyed by the anilox roller 32Y, thereby adjusting the amount of the liquid developer to be supplied to the development roller 20Y.

The development roller 20Y is a cylindrical member, and rotates counterclockwise around the rotational axis as shown in FIG. 2. The development roller 20Y has a layer of an elastic material such as polyurethane rubber, silicone rubber, or NBR disposed on the outer periphery of an inner core made of metal such as iron. The development roller cleaning blade 21Y is composed, for example, of a rubber member having contact with the surface of the development roller 20Y, and disposed on a downstream side of the development nip section, at which the development roller 20Y has contact with the image carrier 10Y, in the rotational direction of the development roller 20Y, and for removing the liquid developer remaining on the development roller 20Y by scraping off the liquid developer.

The compaction corona generator 22Y is an electric field applying section adapted to increase the charging bias of the surface of the development roller 20Y, and applies an electric field to the liquid developer, which is conveyed by the development roller 20Y, in the direction from the compaction corona generator 22Y towards the development roller 20Y in a charging region as shown in FIG. 2.

It should be noted that as the electric field applying section for charging, a compaction roller or the like can be used instead of the corona discharge of the corona discharger shown in FIG. 2. It is preferable that such a compaction roller is a cylindrical member formed as an elastic roller covered with an elastic member similarly to the development roller 20Y having a structure of providing a conductive resin layer or rubber layer as the surface layer of a metal roller base and rotating, for example, clockwise, the reverse direction of that of the development roller 20Y.

On the other hand, a desired electric field is applied to the developer, which is carrier by the development roller 20Y and provided with the charge by the compaction corona generator, at the development nip section where the development roller 20Y has contact with the image carrier 10Y, thereby developing the developer in accordance with the latent image on the image carrier 10Y. Further, the residual part of the developer after the development is scraped off by the development roller cleaning blade 21Y to be removed therefrom, and drops in a recovery section in the developer container 31Y to be reused. It should be noted that the carrier and the toner particles thus reused is not in a color-mixture state.

The image carrier squeezing device disposed on the upstream side of the primary transfer section is disposed opposed to the image carrier 10Y on the downstream side of the development roller 20Y, and for recovering the surplus developer of the toner image developed on the image carrier 10Y. As shown in FIG. 2, the image carrier squeezing device is composed of the image carrier squeezing rollers 13Y, 13Y′ each formed of an elastic roller member having a surface covered with an elastic member and rotating while having slidable contact with the image carrier 10Y, and the image carrier squeezing roller cleaning blades 14Y, 14Y′ slidably pressed against the image carrier squeezing rollers 13Y, 13Y′ to clean the surfaces thereof, respectively. The image carrier squeezing device has a function to recover the superfluous carrier and the superfluous toner particle, which is fundamentally unnecessary, from the developer developed on the image carrier 10Y, thus increasing the toner particle ratio in a visible image. Although in the present embodiment, there are provided a plurality of image carrier squeezing rollers 13Y, 13Y′ as the image carrier squeezing device in the anterior stage of the primary transfer, it is possible to form the image carrier squeezing device of a single image carrier squeezing roller. Further, it is also possible to configure the image carrier squeezing device so that one of the plurality of image carrier squeezing rollers 13Y, 13Y′ selectively contacts with and detached from the image carrier in accordance with, for example, the condition of the liquid developer.

In the primary transfer section 50Y, the developer image thus developed on the image carrier 10Y is transferred to the intermediate transfer member 40 by the primary transfer roller 51Y. Here, the image carrier 10Y and the intermediate transfer member 40 are configured to move at a constant velocity, thus the driving load of rotation and movement can be reduced, and the disturbing operation to the overt toner image of the image carrier 10Y can also be suppressed.

The intermediate transfer member 40, on which the developed image of the image carrier of each of the colors yellow (Y), magenta (M), cyan (C), and black (K) is transferred so as to overlap the colors while passing through the nip of the primary transfer section 50 of each of the colors, enters the nip section of the secondary transfer unit 60.

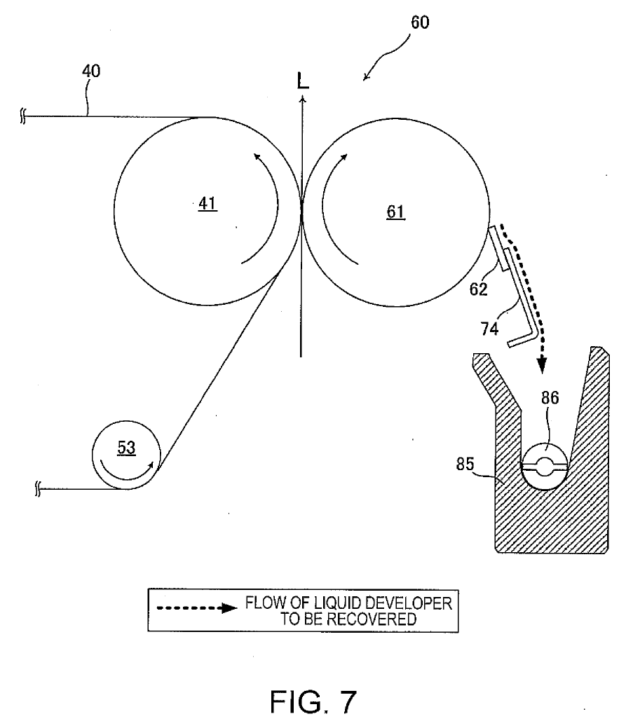

FIG. 7 is a diagram showing a configuration of a cleaning device in a secondary transfer unit. The secondary transfer unit 60 has a secondary transfer roller 61 disposed so as to be opposed to the belt drive roller 41 holding the intermediate transfer member 40 therebetween, and transfers the monochromatic toner image and the full-color toner image formed on the intermediate transfer member 40 to the recording medium such as a paper sheet, a film, or cloth conveyed through the sheet member conveying path L at a transfer position where the secondary transfer roller 61 is disposed.

The secondary transfer roller cleaning blade 62 has contact with the secondary transfer roller 61, and scrapes off the liquid developer attached to the secondary transfer roller 61. In particular, cleaning with the secondary transfer roller cleaning blade 62 is useful in the case in which the recording medium expected to be conveyed in the normal condition fails to reach the secondary transfer position due to a paper jam and so on. When the secondary transfer process is executed successfully, the secondary transfer roller cleaning blade 62 mainly scrapes off the carrier component. The reference numeral 74 denotes a secondary transfer roller cleaning blade holding member.

The liquid developer scraped off by the secondary transfer roller cleaning blade 62 drops along the secondary transfer roller cleaning blade holding member 74. The liquid developer thus dropped is received by a secondary transfer unit recovery reservoir 85 having a recessed section, and conveyed in an axial direction of a rotating shaft of a recovery screw 86 provided to the recessed section in response to the rotation of the recovery screw 86. The recovery screw 86 is provided with spiral blades or the like, and is adapted to convey the liquid developer in the axial direction while rotating. The liquid developer conveyed by the recovery screw 86 is discharged to a recovery mechanism not shown.

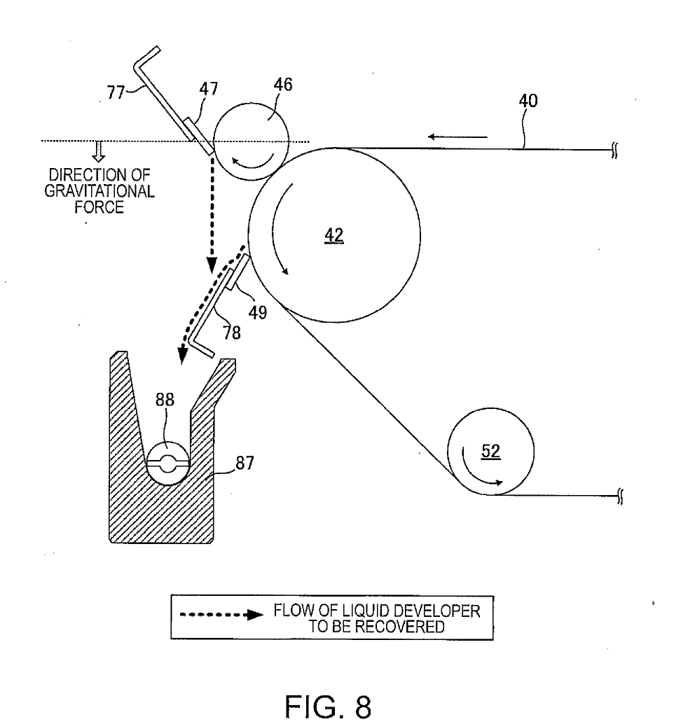

The intermediate transfer member 40 having passed through the secondary transfer unit 60 is circulated for accepting the transferred image again in the primary transfer sections 50, and the cleaning of the intermediate transfer member 40 is executed on the upstream side of the primary transfer sections 50. FIG. 8 is a diagram showing a configuration of a cleaning device of the intermediate transfer member.

An intermediate transfer member cleaning roller 46 is disposed so as to have contact with the intermediate transfer member 40 while being opposed to the tension roller 42. The intermediate transfer member cleaning roller 46 is a roller having an urethane rubber surface layer, and it is arranged that a bias voltage for attracting the toner particles in the liquid developer is applied to the intermediate transfer member cleaning roller 46. The intermediate transfer member cleaning roller 46 rotates clockwise while having contact with the intermediate transfer member 40, thereby performing cleaning while attracting the liquid developer (mainly the toner particles) remaining on the intermediate transfer member 40 with the bias voltage. The bias voltage is set higher than the voltage applied to the cleaning rollers of the image carrier 16. This is because the adhesive force of the toner particle components of the liquid developer to the intermediate transfer member 40 is greater than that to the image carriers 10.

There is disposed an intermediate transfer member cleaning blade of the cleaning roller 47 having contact with the intermediate transfer member cleaning roller 46 at a position within the lower half of the intermediate transfer member cleaning roller 46 viewed from the direction of gravitational force thereof, and the intermediate transfer member cleaning blade of the cleaning roller 47 scrapes off the liquid developer recovered by the intermediate transfer member cleaning roller 46. The liquid developer scraped off by the intermediate transfer member cleaning blade of the cleaning roller 47 drops vertically downward.

On the downstream side of the intermediate transfer member cleaning roller 46, there is further disposed an intermediate transfer member cleaning blade 49 having contact with the intermediate transfer member 40 and for cleaning the intermediate transfer member 40. The reference numerals 77, 78 denote cleaning blade holding members for holding the respective cleaning blades.

Further, an intermediate transfer member recovery reservoir 87 has a recessed section for receiving both of the liquid developer rich in the solid components scraped off by the intermediate transfer member cleaning blade of the cleaning roller 47 and the liquid developer rich in the carrier component scraped off by the intermediate transfer member cleaning blade 49.

The recessed section of the intermediate transfer member recovery reservoir 87 is provided with a recovery screw 88, and when the recovery screw 88 rotates, spiral blades thereof convey the liquid developer received by the recessed section in the axial direction of the rotating shaft of the recovery screw 88. The liquid developer conveyed by the recovery screw 88 is discharged to the recovery mechanism not shown.

Since the liquid developer scraped oft by the intermediate transfer member cleaning blade of the cleaning roller 47 is a liquid developer rich in the solid components, and has a lot of solid components, the easiness in conveying the liquid developer along the axial direction of the rotating shaft of the recovery screw 88 is poor. Therefore, by adopting the positional relationship shown in FIG. 8, there is obtained an advantage that the liquid developer rich in the carrier component, which is scraped off by the intermediate transfer member cleaning blade 49 joins together with the liquid developer scraped off by the intermediate transfer member cleaning blade of the cleaning roller 47 on the cleaning blade holding member 78, thus the easiness in conveying the liquid developer to be recovered is improved. Therefore, the easiness in treatment in the intermediate transfer member recovery reservoir 87 is improved. Here, although the example of dropping the liquid developer scraped off by the intermediate transfer member cleaning blade of the cleaning roller 47 on the cleaning blade holding member 78 is described, it is possible to arrange that the liquid developer drops directly on the intermediate transfer member cleaning blade 49.

On the cleaning blade holding member 78, the liquid developer rich in the solid components dropping from the intermediate transfer member cleaning blade of the cleaning roller 47 and the liquid developer rich in the carrier component scraped off by the intermediate transfer member cleaning blade 49 are mixed with each other, thus the easiness in conveying thereof is improved. Further, such improvement in the easiness in conveying can make a contribution to down sizing of the device.

The intermediate transfer member 40 has a three-layer structure in which an elastic intermediate layer made of polyurethane is disposed on a polyimide base layer, and further a PFA surface layer is disposed thereon. Such an intermediate transfer member 40 is used so that the intermediate transfer member is tensioned by the belt drive roller 41, the tension rollers 42, 52, 53 on the polyimide base layer side, and the toner image is transferred on the PFA surface layer side.

The intermediate transfer member 40 thus formed to have elasticity easily follows the surface of the recording medium with good response, and is therefore particularly effective for feeding toner particles with small particle size into the recessed sections of the recording medium to transfer them thereon.

As described above, the intermediate transfer member 40 has elasticity, and therefore, it is difficult to press the blade for cleaning against the intermediate transfer member with high pressure. However, in the present embodiment, since the configuration of cleaning the intermediate transfer member 40 with the intermediate transfer member cleaning roller 46 to which the bias voltage is applied is adopted, there is no possibility of damaging the intermediate transfer member 40 with elasticity.

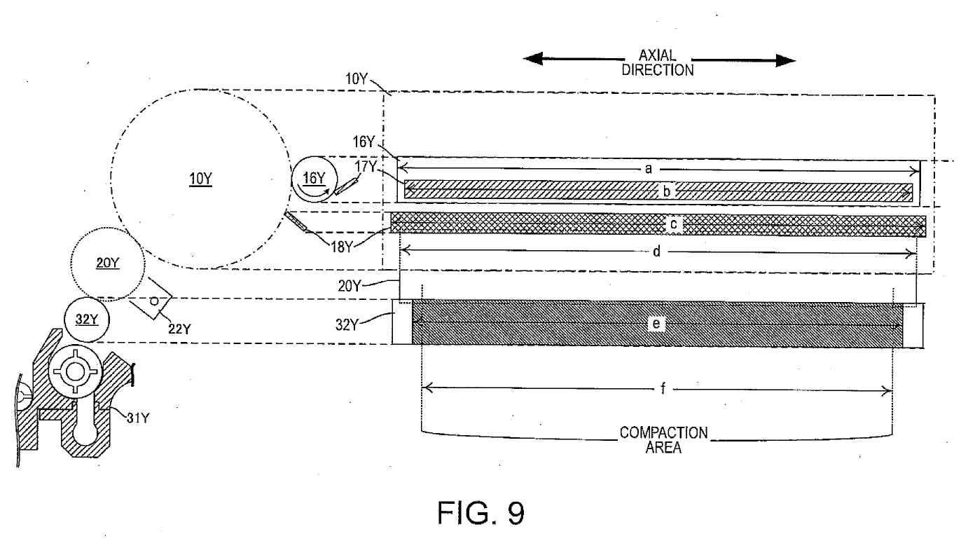

Then, the dimensional relationship in the axial direction of the rollers in the peripheral area of the cleaning device of the image carriers 10 will be explained. FIG. 9 is a diagram showing the dimensional relationship in the axial direction in the peripheral area of the cleaning device according to the embodiment of the invention. Although FIG. 9 shows the dimensional relationship in the peripheral area of the cleaning device for yellow (Y), the cleaning devices for other colors can be configured in substantially the same manner.

FIG. 9 includes a diagram (in the right) of the image carrier 10Y, the cleaning roller of the image carrier 16Y, the cleaning blade of the cleaning roller of the image carrier 17Y, the image carrier cleaning blade 18Y, the development roller 20Y, and the anilox roller 32Y viewed from a direction traversing the axial direction thereof, and a cross-sectional view (in the left) corresponding thereto.

Further, the reference letters a through g in FIG. 9 each denote a length, wherein a denotes the length of the cleaning roller of the image carrier 16Y in the axial direction, b denotes the length of the cleaning blade of the cleaning roller of the image carrier 17Y in the axial direction, c denotes the length of the image carrier cleaning blade 18Y in the axial direction, d denotes the length of the development roller 20Y in the axial direction, e denotes the length of the grooved area of the anilox roller 32Y, and f denotes the length of the area on the development roller 20Y charged by the compaction corona generator.

Hereinafter, the dimensional relationships characteristic of the present embodiment will be explained.

In the present embodiment, the length (a) of the cleaning roller of the image carrier 16Y in the axial direction is set to be longer than the length (b) of the cleaning blade of the cleaning roller of the image carrier 17Y in the axial direction, and shorter than the length (c) of the image carrier cleaning blade 18Y in the axial direction. By setting the length (a) of the cleaning roller of the image carrier 16Y in the axial direction to be longer the length (b) of the cleaning blade of the cleaning roller of the image carrier 17Y in the axial direction (i.e., (a)>(b)), it can be prevented that the inside of the housing of the image forming device is contaminated by the liquid accumulated by wrapping the carrier removed by the cleaning blade of the cleaning roller of the image carrier 17Y for cleaning the cleaning roller of the image carrier 16Y around the end of the cleaning roller of the image carrier 16Y.

Further, by setting the length (c) of the image carrier cleaning blade 18Y in the axial direction to be shorter than the length (a) of the cleaning roller of the image carrier 16Y in the axial direction (i.e., (c)>(a)), it is possible to recover the liquid ring caused by the cleaning roller of the image carrier 16Y by the image carrier cleaning blade 18Y.

According to the configuration described above, the formation of the liquid ring can be suppressed as much as possible. Therefore, it is eliminated that the case in which the inside of the device is contaminated with the drop of the liquid developer from the liquid ring, and the amount of consumption of the liquid developer can also be reduced.

Further, in the present embodiment, the length (d) of the development roller 20Y in the axial direction is set to be shorter than the length (a) of the cleaning roller of the image carrier 16Y in the axial direction. It is preferable to set the length (d) of the development roller 20Y in the axial direction to be shorter than the length (a) of the cleaning roller of the image carrier 16Y in the axial direction, because it becomes easy to recover the solid components developed on the image carrier by the development roller 20Y.

Further, in the present embodiment, the length (e) of the grooved area to which the grooves are provided in the axial direction of the anilox roller 32Y is set to be shorter than the length (b) of the cleaning blade of the cleaning roller of the image carrier 17Y in the axial direction. It is preferable that the length (e) of the grooved area provided with the grooves disposed on the outer periphery of the anilox roller 32Y in the axial direction is arranged to be shorter than the length (b) of the cleaning blade of the cleaning roller of the image carrier 17Y in the axial direction, because it becomes thereby possible to recover the solid contents of the developer (i.e., the developer formed on the photoconductor) formed on the development roller 20Y throughout the entire width thereof with the cleaning roller of the image carrier 16Y, and further, to recover the liquid developer apt to have a higher solid-component concentration with the cleaning blade of the cleaning roller of the image carrier 17Y.

Further, in the present embodiment, the length (f) of the compaction area in which the compaction corona generator performs charging on the development roller 20Y is set shorter than the length (b) of the cleaning blade of the cleaning roller of the image carrier 17Y in the axial direction.

It is preferable to arrange that the length (f) of the compaction area in which the compaction is executed on the development roller 20Y is shorter than the length (b) of the cleaning blade of the cleaning roller of the image carrier 17Y in the axial direction, because it becomes thereby possible to recover the liquid developer, which includes the toner particles charged by the compaction corona generator to have a higher solid component concentration and becomes hard to be removed by a simple blade, and further to recover the liquid developer, which includes the toner particles with a higher solid component concentration recovered by the cleaning roller of the image carrier 16Y, from the cleaning roller of the image carrier 16Y with the cleaning blade of the cleaning roller of the image carrier 17Y.

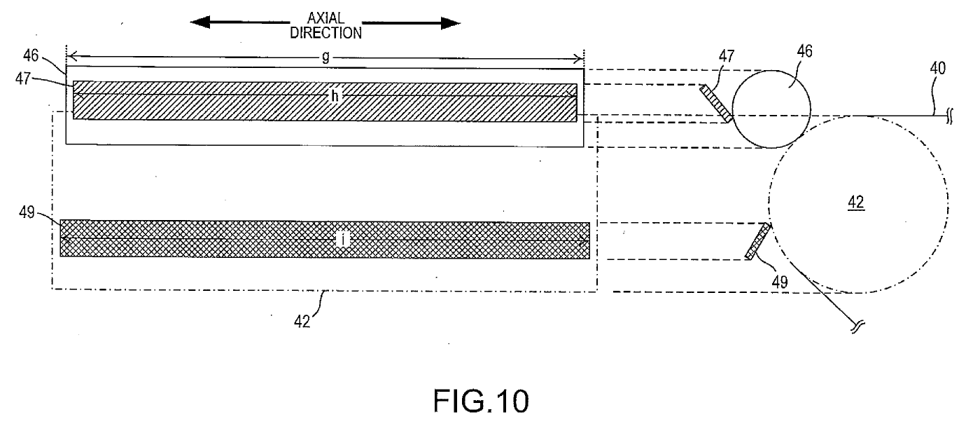

Then, the dimensional relationship in the axial direction of the rollers in the peripheral area of the cleaning device of the intermediate transfer member 40 will be explained. FIG. 10 is a diagram showing the dimensional relationship in the axial direction in the peripheral area of the cleaning device according to the embodiment of the invention.

FIG. 10 includes a diagram (in the left) of the tension roller 42, the intermediate transfer member cleaning roller 46, the intermediate transfer member cleaning blade of the cleaning roller 47, and the intermediate transfer member cleaning blade 49 viewed from a direction traversing the axial direction thereof, and a cross-sectional view (in the right) corresponding thereto.

Further, the reference letters g through i each denote a length, wherein g denotes the length of the intermediate transfer member cleaning roller 46 in the axial direction, h denotes the length of the intermediate transfer member cleaning blade of the cleaning roller 47 in the axial direction, i denotes the length of the intermediate transfer member cleaning blade 49 in the axial direction.

Hereinafter, the dimensional relationships characteristic of the present embodiment will be explained.

In the present embodiment, the length (g) of the intermediate transfer member cleaning roller 46 in the axial direction is set to be longer than the length (h) of the intermediate transfer member cleaning blade of the cleaning roller 47 in the axial direction, and shorter than the length (i) of the intermediate transfer member cleaning blade 49 in the axial direction. By setting the length (g) of the intermediate transfer member cleaning roller 46 in the axial direction to be longer than the length (h) of the intermediate transfer member cleaning blade of the cleaning roller 47 in the axial direction (i.e., (g)>(h)), it can be prevented that the inside of the housing of the image forming device is contaminated by the liquid accumulated by wrapping the carrier removed by the intermediate transfer member cleaning blade of the cleaning roller 47 for cleaning the intermediate transfer member cleaning roller 46 around the end of the intermediate transfer member cleaning roller 46.

Further, by setting the length (i) of the intermediate transfer member cleaning blade 49 in the axial direction to be longer than the length (g) of the intermediate transfer member cleaning roller 46 in the axial direction (i.e., (i)>(g)), it is possible to recover the liquid ring caused on the intermediate transfer member cleaning roller with the intermediate transfer member cleaning blade 49.

According to the configuration described above, the formation of the liquid ring can be suppressed as much as possible. Therefore, it is eliminated that the case in which the inside of the device is contaminated with the drop of the liquid developer from the liquid ring, and the amount of consumption of the liquid developer can also be reduced.

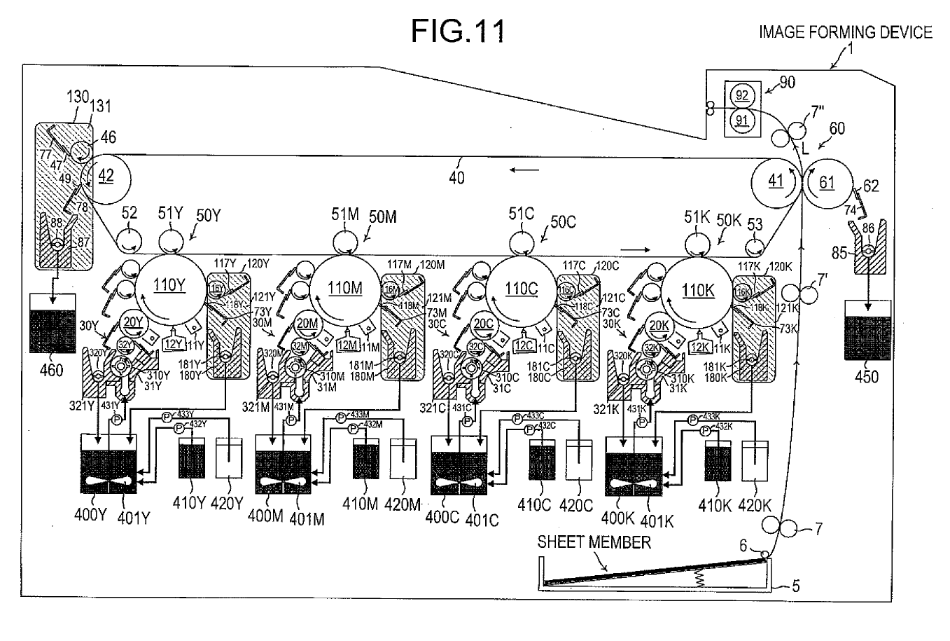

Another embodiment of the invention will hereinafter be explained. FIG. 11 is a diagram showing principal constituents forming an image forming device according to another embodiment of the invention. In the present embodiment, a cleaning device having the photoconductor as a cleaning target and a cleaning device having the intermediate transfer member as a cleaning target are each formed as a cleaning unit.

In the image forming device 1 according to the another embodiment, it is arranged that sheet members set in a paper feed cassette 5 are discharged to the sheet member conveying path L one-by-one at a predetermined timing by a pickup roller 6. In the sheet member conveying path L, pairs of conveying rollers 7, 7′ convey the sheet member up to the secondary transfer position, and the monochromatic toner image or the full-color toner image formed on the intermediate transfer member 40 is transferred to the sheet member. A pair of conveying rollers 7″ further conveys the sheet member, on which the secondary transfer is executed, to a fixing section 90. The fixing section 90 is composed of a heating roller 91 and a pressure roller 92 biased towards the heating roller 91 side with predetermined pressure, and for melting the monochromatic toner image or the full-color toner image transferred on the sheet inserted into a nip section between the rollers to be fixed on the sheet member such as a paper sheet.

Photoconductor cleaning units 120Y, 120M, 120C, and 120K for cleaning photoconductors 110Y, 110M, 110C, and 110K form units by holding principal sections such as photoconductor cleaning rollers 116Y, 116M, 116C, and 116K, photoconductor cleaning blades of the cleaning roller 117Y, 117M, 117C, and 117K, photoconductor cleaning blades 118Y, 118M, 118C, and 118K, and blade holding members with pairs of photoconductor cleaning unit side plates 121Y, 121M, 121C, and 121K, respectively, from the both sides in the axial direction.

Further, an intermediate transfer member cleaning unit 130 for cleaning the intermediate transfer member 40 forms a unit by holding principal sections such as the intermediate transfer member cleaning roller 46, the intermediate transfer member cleaning blade of the cleaning roller 47, the intermediate transfer member cleaning blade 49, and blade holding members with pair of intermediate transfer member cleaning unit side plates 131 from the both sides in the axial direction.

The photoconductor cleaning rollers 116Y, 116M, 116C, and 116K are rollers each having a urethane rubber surface layer, and rotate counterclockwise while having contact with the photoconductors 110Y, 110M, 110C, and 110K, thereby removing residual liquid developer after transfer and the liquid developer, which has not yet been transferred, on the photoconductors 110Y, 110M, 110C, and 110K, respectively. The photoconductor cleaning rollers 116Y, 116M, 116C, and 116K are each provided with a bias voltage so as to attract the toner particles in the liquid developer. Therefore, what is recovered by the photoconductor cleaning rollers 116Y, 116M, 116C, and 116K should be the liquid developer containing a lot of toner particles. The liquid developers rich in the solid components and recovered by the photoconductor cleaning rollers 116Y, 116M, 116C, and 116K are scraped off by the photoconductor cleaning blades of the cleaning roller 117Y, 117M, 117C, and 117K having contact with the photoconductor cleaning rollers 116Y, 116M, 116C, and 116K, respectively, and drop vertically downward.

On the other hand, the photoconductor cleaning blades 118Y, 118M, 118C, and 118K having contact with the photoconductors 110Y, 110M, 110C, and 110K on the downstream side of the photoconductor cleaning rollers 116Y, 116M, 116C, and 116K drop downward the liquid developers rich in the carrier component disposed on the photoconductors 110Y, 110M, 110C, and 110K via the cleaning blade holding members 73Y, 73M, 73C, and 73K, respectively.

On the cleaning blade holding members 73Y, 73M, 73C, and 73K, the liquid developers rich in the solid components dropping from the photoconductor cleaning blades of the cleaning roller 117Y, 117M, 117C, and 117K and the liquid developers rich in the carrier component scraped off by photoconductor cleaning blades 118Y, 118M, 118C, and 118K are mixed with each other, respectively, thus the easiness in conveying thereof is improved. Further, such improvement in the easiness in conveying can make a contribution to down sizing of the device.

Photoconductor recovery reservoirs 180Y, 180M, 180C, and 180K have recessed sections for receiving both of the liquid developers rich in the solid components scraped off by the photoconductor cleaning blades of the cleaning roller 117Y, 117M, 117C, and 117K and the liquid developers rich in the carrier component scraped off by the photoconductor cleaning blades 118Y, 118M, 118C, and 118K, respectively.

The recessed sections of the photoconductor recovery reservoirs 110Y, 180M, 180C, and 180K are provided with recovery screws 181Y, 181M, 181C, and 181K, and when the recovery screws 181Y, 181M, 181C, and 181K rotate, spiral blades thereof convey the liquid developer received by the recessed sections in the axial direction of the rotating shafts of the recovery screws 181Y, 181M, 181C, and 181K, respectively. The liquid developers conveyed by the recovery screws 181Y, 181M, 181C, and 181K are discharged to recycling mechanisms, respectively.

Then, the recycling mechanism of the liquid developer disposed outside the developer container according to the embodiment of the invention will be explained. FIG. 11 is a diagram schematically showing the conditions of the liquid developer flowing into each of the developer containers and the liquid developer flowing out of each of the developer containers. In FIG. 11, the reference marks 400Y, 400M, 400C, and 400K denote concentration adjusting tanks, the reference marks 401Y, 401M, 401C, and 401K denote agitation units, the reference marks 410Y, 410M, 410C, and 410K denote high concentration toner tanks, the reference marks 420Y, 420M, 420C, 420K denote carrier tanks, and the reference numerals 431 through 433 denote pumps, and the reference numerals 450, 460 denote waste toner tanks.

The concentration adjusting tanks 400Y, 400M, 400C, and 400K are tanks for preparing the liquid developers with the toner particle solid component concentration of about 206 to be supplied to supply reservoirs 310Y, 310M, 310C, and 310K of developer containers 31Y, 31M, 31C, and 31K, respectively. Further, the high concentration toner tanks 410Y, 410M, 410C, and 410K are for storing the high concentration toners with the toner solid component concentration higher than about 20%, and the carrier tanks 420Y, 420M, 420C, and 420K are tanks for storing the carrier liquid.

The concentration adjusting tanks 400Y, 400M, 400C, and 400K accept the high concentration toners supplied from the high concentration toner tanks 410Y, 410M, 410C, and 410K, respectively. In order for these operations, the pumps 432Y, 432M, 432C, and 432K are driven.

Further, it is arranged that the concentration adjusting tanks 400Y, 400M, 400C, and 400K accept the carrier liquid supplied from the carrier tanks 420Y, 420M, 420C, and 420K by driving the pumps 433Y, 433M, 433C, and 433K, respectively.

The concentration adjusting tanks 400Y, 400M, 400C, and 400K are each provided with a toner concentration detection section such as an optical sensor, not shown, and the control section, not shown, performs on-off control of the pumps 432, 433 so that the concentration of the liquid developer inside the concentration adjusting tank 400 becomes appropriate while detecting the concentration with the toner concentration detection section. Further, it is arranged that the inside of the concentration adjusting tanks 400Y, 400M, 400C, and 400K is agitated by driving the agitation units 410Y, 401M, 401C, and 401K disposed inside the concentration adjusting tanks 400Y, 400M, 400C, and 400K, respectively.

It is arranged that in the operating state of the device, the pumps 431Y, 431M, 431C, and 431K always supply the liquid developers from the concentration adjusting tanks 400Y, 40M, 400C, and 400K to the supply reservoirs 310Y, 310M, 310C, and 310K, respectively. Further, it is also arranged that the liquid developers in the recovery reservoirs 320Y, 320M, 320C, and 320K are conveyed to the concentration adjusting tanks 400Y, 400M, 400C, and 400K by the rotational operations of the recovery screws 321Y, 321M, 321C, and 321K in the recovery reservoirs 320Y, 320M, 320C, and 320K, respectively.

The liquid developer dropping from the secondary transfer roller cleaning blade 62 for scraping off the liquid developer attached to the secondary transfer roller 61 while having contact with the secondary transfer roller 61 is received by the secondary transfer unit recovery reservoir 85 provided with a recessed section, and then conveyed in the axial direction of the rotating shaft in response to the rotation of the recovery screw 86 disposed in the recessed section. The recovery screw 86 is provided with spiral blades or the like, and is adapted to convey the liquid developer in the axial direction while rotating. The liquid developer conveyed by the recovery screw 86 is discharged to the waste toner tank 450.

The intermediate transfer member recovery reservoir 87 has a recessed section for receiving both of the liquid developer rich in the solid components scraped off by the intermediate transfer member cleaning blade of the cleaning roller 47 and the liquid developer rich in the carrier component scraped off by the intermediate transfer member cleaning blade 49.

The recessed section of the intermediate transfer member recovery reservoir 87 is provided with a recovery screw 88, and when the recovery screw 88 rotates, spiral blades thereof convey the liquid developer received by the recessed section in the axial direction of the rotating shaft of the recovery screw 88. The liquid developer conveyed by the recovery screw 88 is discharged to the waste toner tank 460.

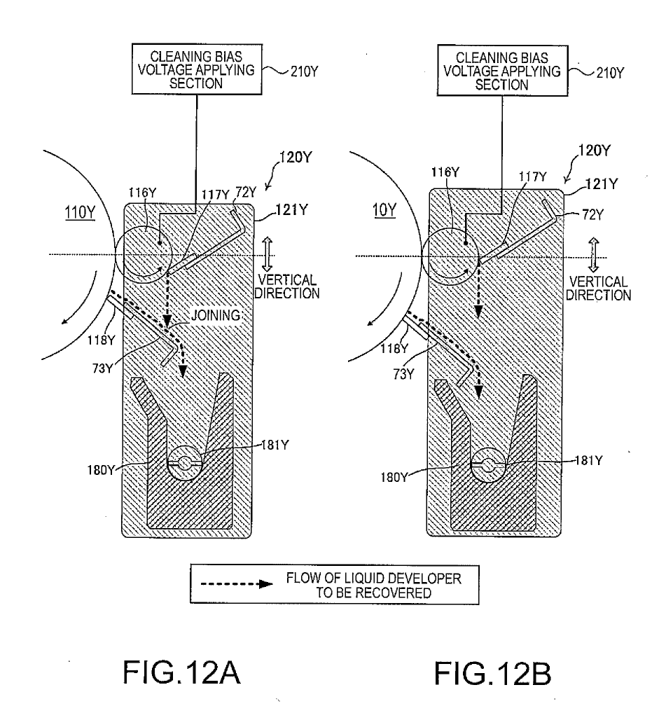

FIGS. 12A and 12B are diagrams showing an example of an arrangement of the cleaning device according to the another embodiment of the invention. Although FIG. 12A and FIG. 12B both show the cleaning device according to the embodiment of the invention, the positions at which the photoconductor cleaning blade of the cleaning roller 117Y and the photoconductor cleaning blade 118Y have contact therewith are different from each other.

In the cleaning device of the embodiment of the invention, the position at which the photoconductor cleaning blade of the cleaning roller 117Y have contact with the photoconductor cleaning roller 116Y is preferably in the lower half of the photoconductor cleaning roller 116Y viewed from the vertical direction thereof as shown in FIGS. 12A and 12B. The reason therefor is that the liquid developer scraped off by the photoconductor cleaning blade of the cleaning roller 117Y can be dropped without running along the photoconductor cleaning roller 116Y.

The liquid developer scraped off by the photoconductor cleaning blade of the cleaning roller 117Y is dropped on the cleaning blade holding member 73Y in the example shown in FIG. 12A, while it is dropped directly to the recessed section of the photoconductor recovery reservoir section 80Y in the example shown in FIG. 12B.

In either of the cases shown in FIGS. 12A, 12B, in the present embodiment, the photoconductor cleaning blade of the cleaning roller 117Y is disposed so as to have contact with the photoconductor cleaning roller 116Y at a position on an imaginary line of an intersection between a plane passing through the center of the rotational axis of the photoconductor cleaning roller 116Y and perpendicular to the vertical direction and the surface of the photoconductor cleaning roller 116Y, or a position lower then the imaginary line in the vertical direction.

Further, a cleaning bias voltage applying section 210Y applies a bias voltage to the photoconductor cleaning roller 116Y so as to attract the toner particles in the liquid developer. The bias voltage applied by the cleaning bias voltage applying section 210Y is about −200V, for example.

Since the liquid developer scraped off by the photoconductor cleaning blade of the cleaning roller 117Y is a liquid developer rich in the solid components, and has a lot of solid components, the easiness in conveying the liquid developer along the axial direction of the rotating shaft of the recovery screw 181Y is poor. Therefore, by adopting the positional relationship shown in FIG. 12A, there is obtained an advantage that the liquid developer rich in the carrier component, which is scraped off by the photoconductor cleaning blade 118Y joins together with the liquid developer scraped off by the photoconductor cleaning blade of the cleaning roller 117Y on the cleaning blade holding member 73Y, thus the easiness in conveying the liquid developer to be recovered is improved. Therefore, the easiness in treatment in the photoconductor recovery reservoir section 180Y is improved. Here, although the example of dropping the liquid developer scraped off by the photoconductor cleaning blade of the cleaning roller 117Y on the cleaning blade holding member 73Y is described, it is possible to arrange that the liquid developer drops directly on the photoconductor cleaning blade 118Y.

In such a configuration of the present embodiment, the photoconductor recovery reservoir section 180Y recovers both of the liquid developer removed by the photoconductor cleaning blade of the cleaning roller 117Y and the liquid developer removed by the photoconductor cleaning blade 118Y. By conveying the recovered substance recovered by the photoconductor cleaning roller 116Y and apt to have a relatively high concentration of the solid components (the toner components) together with the recovered substance recovered by the photoconductor cleaning blade 118Y and rich in the carrier component, it becomes easier to convey the recovered substance recovered by the photoconductor creaming roller 116Y, which is apt to have a relatively high concentration of the solid components, and downsizing of the device can be achieved.

Further, in the present embodiment, since the carrier used in the liquid developer is a nonvolatile carrier, it becomes possible to improve the easiness in conveying by joining the liquid developer scraped of by the photoconductor cleaning blade of the cleaning roller 117Y and rich in the solid components and the liquid developer scraped off by the photoconductor cleaning blade 118Y and rich in the carrier component together with each other.

Further, in the present embodiment, the surface layer of the photoconductor 110Y is made of amorphous silicon, and such an amorphous silicon surface layer is apt to cause the phenomenon that the toner particles remaining after the transfer process cause frictional electrification with a member having contact therewith such as the blade to damage the member. In the present embodiment, since the cleaning is executed by the configuration mainly composed of the photoconductor cleaning roller 116Y described above on the downstream side of the transfer, there is no chance that the surface layer of the photoconductor 110Y is damaged.

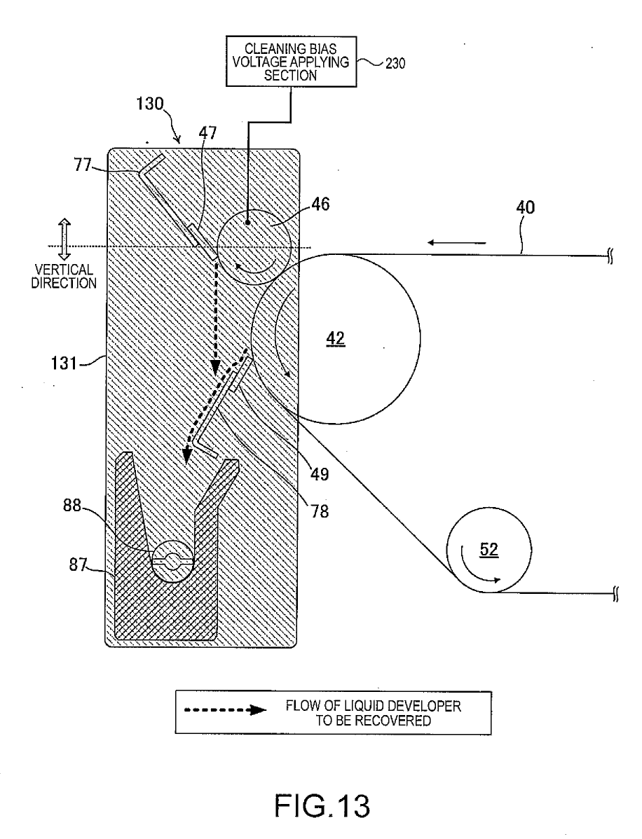

FIG. 13 is a diagram showing an example of a configuration of the cleaning device of the intermediate transfer member according to the another embodiment of the invention. An intermediate transfer member cleaning roller 46 is disposed so as to have contact with the intermediate transfer member 40 while being opposed to the tension roller 42. The intermediate transfer member cleaning roller 46 is a roller having an urethane rubber surface layer, and a cleaning bias voltage applying section 230 applies a bias voltage for attracting the toner particles in the liquid developer to the intermediate transfer member cleaning roller 46. The bias voltage applied by the cleaning bias voltage applying section 230 is about −400V, for example.

The intermediate transfer member cleaning roller 46 rotates clockwise while having contact with the intermediate transfer member 40, thereby performing cleaning while attracting the liquid developer (mainly the toner particles) remaining on the intermediate transfer member 40 with the bias voltage. The bias voltage is set higher in the absolute value than the voltage applied to the photoconductor cleaning rollers 116. This is because the adhesive force of the toner particle components of the liquid developer to the intermediate transfer member 40 is greater than that to the photoconductors 110.

There is disposed an intermediate transfer member cleaning blade of the cleaning roller 47 having contact with the intermediate transfer member cleaning roller 46 at a position within the lower half of the intermediate transfer member cleaning roller 46 viewed from the vertical direction, and the intermediate transfer member cleaning blade of the cleaning roller 47 scrapes off the liquid developer recovered by the intermediate transfer member cleaning roller 46. The liquid developer scraped off by the intermediate transfer member cleaning blade of the cleaning roller 47 drops vertically downward.

In more detail, in the present embodiment, the intermediate transfer member cleaning blade of the cleaning roller 47 is disposed so as to have contact with the intermediate transfer member cleaning roller 46 at a position on an imaginary line of an intersection between a plane passing through the center of the rotational axis of the intermediate transfer member cleaning roller 46 and perpendicular to the vertical direction and the surface of the intermediate transfer member cleaning roller 46, or a position lower then the imaginary line in the vertical direction.

On the downstream side of the intermediate transfer member cleaning roller 46, there is further disposed an intermediate transfer member cleaning blade 49 having contact with the intermediate transfer member 40 and for cleaning the intermediate transfer member 40. The reference numerals 77, 78 denote cleaning blade holding members for holding the respective cleaning blades. In the present embodiment, the cleaning blade holding members 77, 78 are held between the pair of intermediate transfer member cleaning unit side plates 131 from the both sides in the axial direction.

Further, an intermediate transfer member recovery reservoir 87 has a recessed section for receiving both of the liquid developer rich in the solid components scraped off by the intermediate transfer member cleaning blade of the cleaning roller 47 and the liquid developer rich in the carrier component scraped off by the intermediate transfer member cleaning blade 49.

The recessed section of the intermediate transfer member recovery reservoir 87 is provided with a recovery screw 88, and when the recovery screw 88 rotates, spiral blades thereof convey the liquid developer received by the recessed section in the axial direction of the rotating shaft of the recovery screw 88. The liquid developer conveyed by the recovery screw 88 is discharged to the waste toner tank 460.

Since the liquid developer scraped off by the intermediate transfer member cleaning blade of the cleaning roller 47 is a liquid developer rich in the solid components, and has a lot of solid components, the easiness in conveying the liquid developer along the axial direction of the rotating shaft of the recovery screw 88 is poor. Therefore, by adopting the positional relationship shown in FIG. 13, there is obtained an advantage that the liquid developer rich in the carrier component, which is scraped off by the intermediate transfer member cleaning blade 49 joins together with the liquid developer scraped off by the intermediate transfer member cleaning blade of the cleaning roller 47 on the cleaning blade holding member 78, thus the easiness in conveying the liquid developer to be recovered is improved. Therefore, the easiness in treatment in the intermediate transfer member recovery reservoir 87 is improved. Here, although the example of dropping the liquid developer scraped off by the intermediate transfer member cleaning blade of the cleaning roller 47 on the cleaning blade holding member 78 is described, it is possible to arrange that the liquid developer drops directly on the intermediate transfer member cleaning blade 49.

On the cleaning blade holding member 78, the liquid developer rich in the solid components dropping from the intermediate transfer member cleaning blade of the cleaning roller 47 and the liquid developer rich in the carrier component scraped off by the intermediate transfer member cleaning blade 49 are mixed with each other, thus the easiness in conveying thereof is improved. Further, such improvement in the easiness in conveying can make a contribution to down sizing of the device.

The intermediate transfer member 40 has a three-layer structure in which an elastic intermediate layer made of polyurethane is disposed on a polyimide base layer, and further a PFA surface layer is disposed thereon. Such an intermediate transfer member 40 is used so that the intermediate transfer member is tensioned by the belt drive roller 41, the tension rollers 42, 52, 53 on the polyimide base layer side, and the toner image is transferred on the PFA surface layer side.

The intermediate transfer member 40 thus formed to have elasticity easily follows the surface of the recording medium with good response, and is therefore particularly effective for feeding toner particles with small particle size into the recessed sections of the recording medium to transfer them thereon.

As described above, the intermediate transfer member 40 has elasticity, and therefore, it is difficult to press the blade for cleaning against the intermediate transfer member with high pressure. However, in the present embodiment, since the configuration of cleaning the intermediate transfer member 40 with the intermediate transfer member cleaning roller 46 to which the bias voltage is applied by the cleaning bias voltage applying section 230 is adopted, there is no possibility of damaging the intermediate transfer member 40 with elasticity.

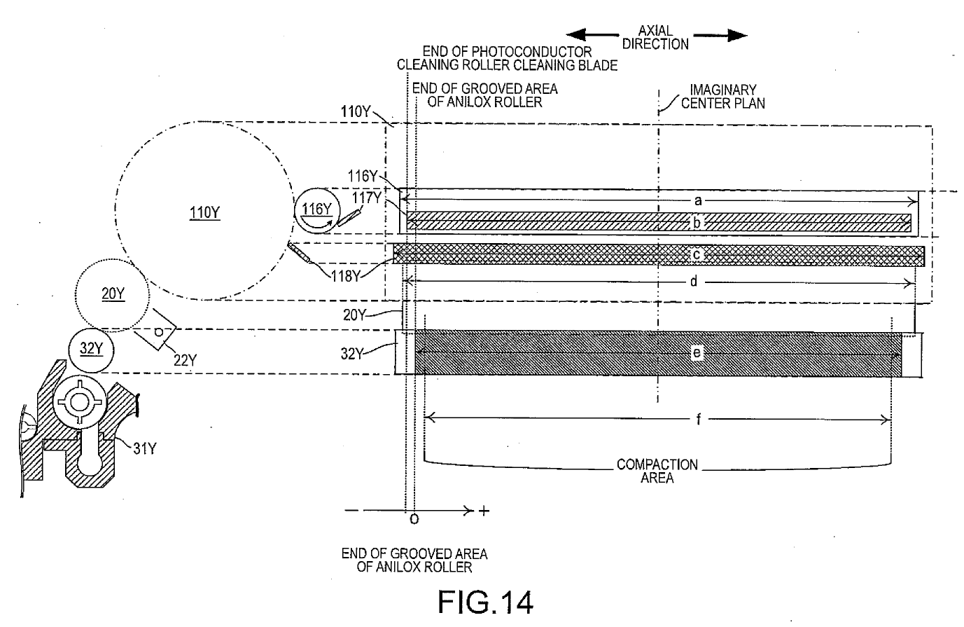

Then, the dimensional relationship in the axial direction of the rollers in the peripheral area of the cleaning device of the photoconductors 110 will be explained. FIG. 14 is a diagram showing the dimensional relationship in the axial direction of the peripheral area of the cleaning device according to the another embodiment of the invention. Although FIG. 14 shows the dimensional relationship in the peripheral area of the cleaning device for yellow (Y), the cleaning devices for other colors can be configured in substantially the same manner.

FIG. 14 includes a diagram (in the right) of the photoconductor 110Y, the photoconductor cleaning roller 116Y, the photoconductor cleaning blade of the cleaning roller 117Y, the photoconductor cleaning blade 118Y, the development roller 20Y, and the anilox roller 32Y viewed from a direction traversing the axial direction thereof, and a cross-sectional view (in the left) corresponding thereto.

Further, the reference letters a through g in FIG. 14 each denote a length, wherein a denotes the length of the photoconductor cleaning roller 116Y in the axial direction, b denotes the length of the photoconductor cleaning blade of the cleaning roller 117Y in the axial direction, c denotes the length of the photoconductor cleaning blade 118Y in the axial direction, d denotes the length of the development roller 20Y in the axial direction, e denotes the length of the grooved area of the anilox roller 32Y, and f denotes the length of a compaction area on the development roller 20Y.

It should be noted that a plane passing through the middle of the grooved area of the anilox roller 32Y and parallel to the vertical direction is defined as an imaginary center plane. Here, in the present embodiment, it is assumed that each of the constituents is disposed symmetrically about the imaginary center plane.

Further, as shown in the drawing, a coordinate system having the origin at one end of the grooved area of the anilox roller 32Y and extending along the axial direction of the roller is defined. In consideration on such a coordinate system, the fact that the length (e) of the grooved area in which the grooves are formed over the anilox roller 32Y in the axial direction thereof is set shorter than the length (b) of the photoconductor cleaning blade of the cleaning roller 117Y in the axial direction corresponds to the fact that an end of the photoconductor cleaning blade of the cleaning roller 117Y is located in the negative region in the coordinate system as shown in the drawing. In the present embodiment, since it is assumed that each of the rollers and blades is disposed symmetrically about the imaginary center plane, the invention is described using the lengths in the axial direction. However, in essentials, it can be said that it is preferable to define the positional relationship between the ends of the respective rollers and blades.

Hereinafter, the dimensional relationships characteristic of the present embodiment will be explained.

In the present embodiment, the length (a) of the photoconductor cleaning roller 116Y in the axial direction is set to be longer than the length (b) of the photoconductor cleaning blade of the cleaning roller 117Y in the axial direction, and shorter than the length (c) of the photoconductor cleaning blade 118Y in the axial direction. By setting the length (a) of the photoconductor cleaning roller 116Y in the axial direction to be shorter than the length (b) of the photoconductor cleaning blade of the cleaning roller 117Y in the axial direction (i.e., (a)>(b)), it can be prevented that the inside of the housing of the image forming device is contaminated by the liquid accumulated by wrapping the carrier removed by the photoconductor cleaning blade of the cleaning roller 117Y for cleaning the photoconductor cleaning roller 116Y around the end of the photoconductor cleaning roller 116Y. Further, by setting the length (c) of the photoconductor cleaning blade 118Y in the axial direction to be shorter than the length (a) of the photoconductor cleaning roller 116Y in the axial direction (i.e., (c)>(a)), it is possible to recover the liquid ring caused by the photoconductor cleaning roller 116Y by the photoconductor cleaning blade 118Y.

According to the configuration described above, the formation of the liquid ring can be suppressed as much as possible. Therefore, it is eliminated that the case in which the inside of the device is contaminated with the drop of the liquid developer from the liquid ring, and the amount of consumption of the liquid developer can also be reduced.

Further, in the present embodiment, the length (d) of the development roller 20Y in the axial direction is set to be shorter than the length (a) of the photoconductor cleaning roller 116Y in the axial direction. It is preferable to set the length (d) of the development roller 20Y in the axial direction to be shorter than the length (a) of the photoconductor cleaning roller 116Y in the axial direction, because it becomes easy to recover the solid components developed on the photoconductor by the development roller 20Y.

Further, in the present embodiment, the length (e) of the grooved area to which the grooves are provided in the axial direction of the anilox roller 32Y is set to be shorter than the length (b) of the photoconductor cleaning blade of the cleaning roller 117Y in the axial direction. It is preferable that the length (e) of the grooved area provided with the grooves disposed on the outer periphery of the anilox roller 32Y in the axial direction is arranged to be shorter than the length (b) of the photoconductor cleaning blade of the cleaning roller 117Y in the axial direction, because it becomes thereby possible to recover the solid contents of the developer (i.e., the developer formed on the photoconductor) formed on the development roller 20Y throughout the entire width thereof with the photoconductor cleaning roller 116Y, and further, to recover the liquid developer apt to have a higher solid-component concentration with the photoconductor cleaning blade of the cleaning roller 117Y.

Further, in the present embodiment, the length (f) of the compaction area in which the compaction corona generator performs charging on the development roller 20Y is set shorter than the length (b) of the photoconductor cleaning blade of the cleaning roller 117Y in the axial direction.

It is preferable to arrange that the length (f) of the compaction area in which the compaction is executed on the development roller 20Y is shorter than the length (b) of the photoconductor cleaning blade of the cleaning roller 117Y in the axial direction, because it becomes thereby possible to recover the liquid developer, which includes the toner particles on which the compaction is executed to have a higher solid component concentration and becomes hard to be removed by a simple blade, and further to recover the liquid developer, which includes the toner particles with a higher solid component concentration thus recovered, from the photoconductor cleaning roller 116Y with the photoconductor cleaning blade of the cleaning roller 117Y.

It should be noted that although various kinds of embodiments are explained in the present specification, embodiments configured by appropriately combining the constituents of the embodiments are also included in the scope of the invention.

The entire disclosure of Japanese Patent Application Nos: 2008-10054, filed Jan. 21, 2008 and 2008-264768, filed Oct. 14, 2008 are expressly incorporated by reference herein.

What is claimed is:

1. An image forming device comprising:
a development section provided with a developer carrier that performs development using a liquid developer including a carrier liquid and toner particles;
an image carrier that carries an image developed by the development section;
a cleaning roller of the image carrier that has contact with the image carrier;
a cleaning blade of the cleaning roller of the image carrier that has contact with the cleaning roller of the image carrier at one of a position on an imaginary line of an intersection between an imaginary plane passing through a center of a rotational axis of the cleaning roller of the image carrier and perpendicular to an imaginary vertical plane and a surface of the cleaning roller of the image carrier and a position lower than the imaginary line in a vertical direction; and
an image carrier recovery reservoir that stores the liquid developer recovered by the cleaning blade of cleaning roller of the image carrier.

2. The image forming device according to claim 1, further comprising:
a cleaning blade of the image carrier that has contact with the image carrier,
wherein the image carrier recovery reservoir stores the liquid developer recovered by the image carrier cleaning blade.

3. The image forming device according to claim 2, further comprising:
a cleaning blade holding member that holds the cleaning blade of the image carrier,
wherein the cleaning blade holding member is disposed vertically below a contact section between the image carrier and the cleaning roller of the image carrier.

4. The image forming device according to claim 2, wherein
a length of the cleaning blade of the image carrier in a first direction is longer than a length of the cleaning blade of cleaning roller of the image carrier in the first direction.

5. The image forming device according to claim 2, wherein
a length of the cleaning roller of the image carrier in a first direction is longer than a length of the cleaning blade of the cleaning roller of the image carrier in the first direction, and shorter than a length of the cleaning blade of the image carrier in the first direction.

6. The image forming device according to claim 1, wherein
the developer carrier is a development roller, and
a length of the development roller in a first direction is shorter than a length of the cleaning roller of the image carrier in the first direction.

7. The image forming device according to claim 6, further comprising:
an applicator roller provided with grooves and that applies the liquid developer to the development roller,
wherein a length of a grooved area of the applicator roller provided with the grooves in the first direction is shorter than a length of the cleaning blade of the cleaning roller of the image carrier in the first direction.

8. The image forming device according to claim 6, further comprising:
a bias applying section that applies a bias to the liquid developer of the development roller,
wherein a length of the bias applying section in the first direction is shorter than a length of the cleaning blade of the cleaning roller of the image carrier in the first direction.

9. The image forming device according to claim 1, wherein
the cleaning roller of the image carrier is provided with a cleaning bias.

10. The image forming device according to claim 1, wherein
the carrier liquid is a nonvolatile carrier.

11. The image forming device according to claim 1, wherein
the image carrier is an amorphous silicon photoconductor.

12. A cleaning device comprising:
a cleaning roller;
a cleaning blade of cleaning roller that has contact with the cleaning roller at one of a position on an imaginary line of an intersection between an imaginary plane passing through a center of a rotational axis of the cleaning roller and perpendicular to an imaginary vertical plane and a surface of the cleaning roller and a position lower than the imaginary line in a vertical direction; and
a reservoir that stores a recovered substance recovered by the cleaning blade of the cleaning roller.

13. The cleaning device according to claim 12, further comprising:
a cleaning blade that has contact with a cleaned member cleaned by the cleaning roller,
wherein the reservoir stores a recovered substance recovered by the cleaning blade.

14. The cleaning device according to claim 13, wherein
a length of the cleaning blade in a first direction is longer than a length of the cleaning blade of the cleaning roller in the first direction.
